(19) United States
(12) Patent Application Publication
(10) Pub. No.: US 2004/0074372 A1
(43) Pub. Date: Apr. 22, 2004

(54) Method and device for producing a series of percussions in close succession by a single operator

(76) Inventor: Patrick Studer, Bourg-les-Valence (FR)

Correspondence Address: STITES & HARBISON PLLC, 1199 NORTH FAIRFAX STREET, SUITE 900, ALEXANDRIA, VA, 22314, US

(21) Appl. No.: 10/450,858

(22) PCT Filed: Dec. 17, 2001
(86) PCT No.: PCT/FR01/04020

(30) Foreign Application Priority Data
Dec. 18, 2000 (FR) 00/16528

(51) Int. Cl. G10D 13/02

(52) U.S. Cl. 84/411 R

(57) ABSTRACT

The invention concerns a method for producing a series of percussions in close succession on at least a percussion instrument such as a bass drum by a single operator. The operator activates successively and repetitively with the leg, then with the foot corresponding to two mobile parts comprising each a beater, adapted to strike the percussion instrument to produce cycle of at least four successive impacts separated in pairs by a time interval less than a quarter of a second.

The present invention relates to a method of producing a series of closely-spaced percussive blows on at least one percussion instrument, such as a bass drum, by a single operator.

It also relates to a device for implementing such a method.

One particularly important although not exclusive application of the invention is in the field of the rhythm music industry using one or more bass drums of drumsets.

Methods and devices using improved means for beating bass drums are already known. With such methods and systems, the beating action of the drummer is by means of a foot-actuated pedal. More precisely, by pressing on this pedal drummers move a beater so that it beats the head of the bass drum.

Such pedals already exist in pairs. For example, a single bass drum may be provided with two pedals for controlling two beaters. A first beater is operated by a first pedal and a second beater is operated by a second pedal actuated by a second foot.

This second pedal is, for example, also connected to the first via a telescopic extension piece, allowing the two beaters to be operated together, if necessary with a single pedal.

There are also in existence systems allowing two bass drums to be used by a single operator.

Two normal pedals are then provided, which require a double set, but played less than a single set.

The main drawback of these known systems stems from the difficulty that the operator has of synchronizing with the operation of the rest of the elements making up the drumset.

Another drawback lies in the difficulty of carrying out a succession of closely-spaced percussive blows.

In particular, it is not possible to obtain really rapid blows on a bass drum, for example in order to give an impression of a drum roll, as may be obtained with drumsticks.

Likewise, with a bass drum, accentuating or emphasizing certain beats of the bar or certain notes has limitations.

It is known in fact that rhythmic accentuation is subject to systematic organization. Thus, in jazz techniques, the even beat, or weak beat known by the name “afterbeat”, that may be accentuated, equal, or distributed between the beats in counterpoint with the melodic accents (for example, in modern jazz) cannot itself be shortened for reasons of striking rate.

Likewise, the nuances of attack, that is to say the accentuated playing of a note obtained by beating the drum, are not always very satisfactory. Moreover, to produce a bass rhythm using his four limbs, the operator currently needs to actuate, independently of the bass drum, “Charleston” cymbals called charlies, or high-hat cymbals. The practice of using two sets is consequently very difficult to achieve.

The method and the device according to the invention overcome these drawbacks.

In particular, the invention offers the possibility of additional blows hitherto unimagined by the drummer, especially as regards notes played off the beat, thanks to the successive or simultaneous use by the drummer of several parts of his legs, namely his knees and/or his thighs and/or his feet, including his heels, in order to beat the bass drum or drums of a drumset.

The present invention thus aims to provide a method and a device for producing a series of closely-spaced percussive blows, especially with a bass drum, that are better than those known previously at meeting the practical requirements, especially in that it allows the drummer to achieve unequalled percussive fluidity, with ease and with a high speed of execution.

In particular, the invention makes it possible to obtain an entirely novel power of accentuation (explosion) when playing the bass drum, for example for reintroducing the orchestra.

We refer here to “attack” that may, thanks to the invention, be immediately followed by rolls on the bass drum with the rippling of extremely rapid notes, possibly as short as demisemiquavers or hemidemisemiquavers over a short time, something that is completely impossible to achieve at the present time.

Thus, a musician will be able to give his playing an expressive quality or intonation that is entirely novel, and this would revolutionize not only rhythm as regards the use of a bass drum, but also any music using this instrument, and in particular rock or Latin music.

Drummers will be able to find novel tonalities and intonations hitherto unknown.

Thanks to the invention, the bass drum becomes in fact more of a rhythm machine. It will make it possible, like other instruments that are easier to handle, to create a new musical voice.

Jazz pieces for percussion, such as “Caravan” interpreted by Jo Jones and Milt Buckner, in which the use of the bass drum is confined to the “beat”, the subtleties of the swing being produced essentially by drumsticks, will thus be able to be enriched with beating of a bass drum that will be just as subtle and as rapid as when it is beaten manually.

The swing and the tension that results [sic] from a succession of attacks and intensities will create new modes of expression.

In addition, with the method and the device according to the invention, bass drum vibration effects, known in wind and/or string instruments, will be able to be sought.

To meet these objectives, the invention provides in particular a method of producing a series of closely spaced percussive blows on at least one percussion instrument by a single operator, characterized in that the operator actuates, successively and repetitively with his corresponding leg and then his corresponding foot, two movable members each having at one end a beater, suitable for beating the percussion instrument in order to produce a drum roll of at least four successive impacts separated in pairs by a time of less than a quarter of a second.

Advantageously, the percussion instrument is a bass drum.

Thus, the operator or drummer when in a seated position can increase and improve his performance, by making novel combinations of blows and by playing bass drum rolls.

For example, he may start bass drum rolls at the end of a solo, in order to introduce a new soloist.

The method of the invention also provides notes and/or a character that do not exist and that have neither been written nor referred to in current rhythm scores.

The drummer also retains the possibility of using a charley, while still executing complex rhythms, which otherwise would require playing two pedals, namely a right foot pedal and a left foot pedal.

As indicated above, new rhythms are therefore possible, enabling the drummer to express creativity and artistic inspiration, and to innovate; this ought to give birth to new styles.

For example, over an underlying and perfectly rhythmic initial tempo, it will be possible to build an architecture based on two-four time, three-four time, etc., or on a reversal of strong beats and weak beats, rekindling the playing inspired by the great classical drummers such as Art Blakey or Elvin Jones.

Above all, by making it easier to maintain complex rhythms with his legs, a drummer is free to exercise his mental capabilities by then being able to devote himself fully to expressing his virtuosity with his hands, thereby allowing rhythm music to reach unequaled peaks.

In advantageous embodiments, one or more of the following arrangements may also be employed:

the successive blows are made by upward movements of the corresponding leg (knee or thigh) and downward movements of the corresponding foot of the operator;

the operator moves the sole of his foot up to actuate the beater with his knee;

the operator actuates four beaters at the same time, in order to produce drum rolls on two different bass drums with his two legs and his corresponding two feet;

the operator actuates, at the same time, on the one hand two beaters on one and the same bass drum and, on the other hand, a hi-hat;

the operator actuates, with only one leg, two beaters in order to beat the same bass drum in an allegro tempo by producing at least two series of four semiquavers in two successive beats;

the operator produces, with the same leg, at least two successive series of four demisemiquavers;

the operator produces a regular succession of at least four blows separated by periods of less than ⅛th of a second.

The invention also provides a device for implementing the method described above.

The invention also provides a device for producing a series of closely-spaced percussive blows on at least one percussion instrument by a single operator, characterized in that the device comprises at least a set of two beaters placed vertically, one at the top and one at the bottom, in opposition on the percussion instrument, each beater being provided with means of actuation by one and the same leg/foot combination of the operator, namely the bottom beater by the operator's foot and the top beater by the operator's knee or thigh, simultaneously and/or in succession at very closely-spaced intervals.

The term “very closely-spaced intervals” should be understood to mean less than 1/4 of a second, for example ⅛ of a second.

By virtue of the device according to the invention, the technical difficulty of playing a bass drum with regular and closely-spaced beats has therefore been solved.

This is because such a device allows the operator or drummer to actuate, in succession and in a regular manner, the two beaters by making vertical up-and-down movements of his leg, the bottom beater being actuated by a downward movement on the pedal and the top beater being actuated by an upward movement.

The invention thus makes it easy for a drummer to produce a series of beats on a bass drum very closely spaced in time, the frequency of the beats varying depending on the speed of the vertical up-and-down motion of his leg. Once again, this ease of executing bass drum “rolls” with just one leg thus opens up new possibilities in music and in sound.

The strength of the movement here is the operator's ankle, allowing him to transmit the energy of the rhythm upward and/or downward.

In one advantageous embodiment, the means of actuating the top beater comprise a mechanism fixed to the hoop of a bass drum and provided with a system having a return chain connected to a movable member suitable for cooperating with the operator's knee and/or thigh.

Advantageously, the device includes a second bass drum and a second set of two beaters with which said second bass drum is equipped, thus offering the operator the possibility of creating successions of sounds of variable intensity and in very high tempi with his two legs.

The drummer may in this way, and if he so desires, play using at will one, two, three or even four beaters.

This results in a style of playing a bass drum that is very effective and full of intelligence, invention and humor, which can swing with new sonority.

However, and in the latter configuration (which gives preference to the playing of bass drums), it is no longer possible simultaneously to actuate the high-hat pedal, both legs of the musician being occupied in actuating the bass drum beaters.

Advantageously, the device also includes a retractable instrument suitable for cooperating with the top beater, for example formed by a bell, or a wheel equipped with various instruments (bells, triangles, kettle drums, etc.) allowing said instruments to be presented opposite said top beater in succession. Such a wheel will usually be employed in the context of Latin-American music for example.

The invention will be more clearly understood on reading the description that follows of an embodiment given by way of nonlimiting example.

The description refers to the drawings which accompany it, in which:

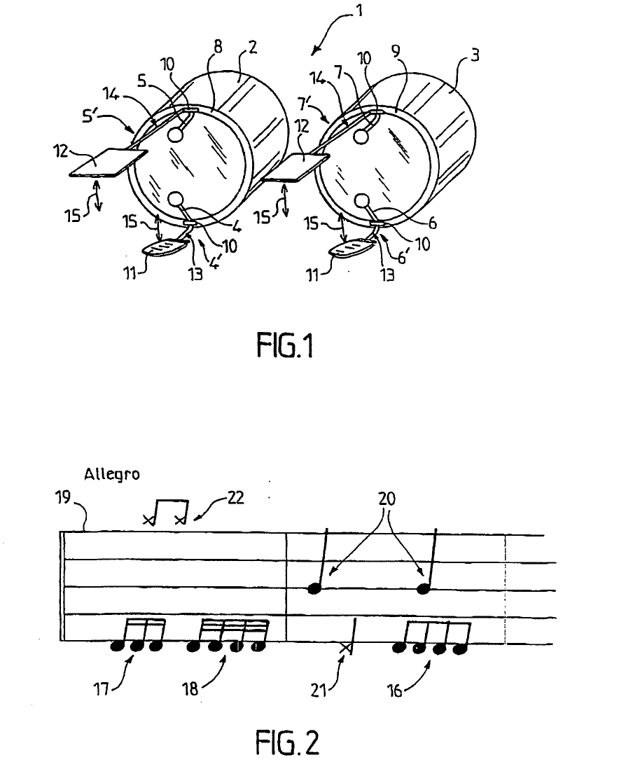

FIG. 1 is a schematic view of one embodiment of an improved beating device according to the invention, applied to two bass drums;

FIG. 2 is an example of a novel score that can be used with the method and/or the device according to the invention;

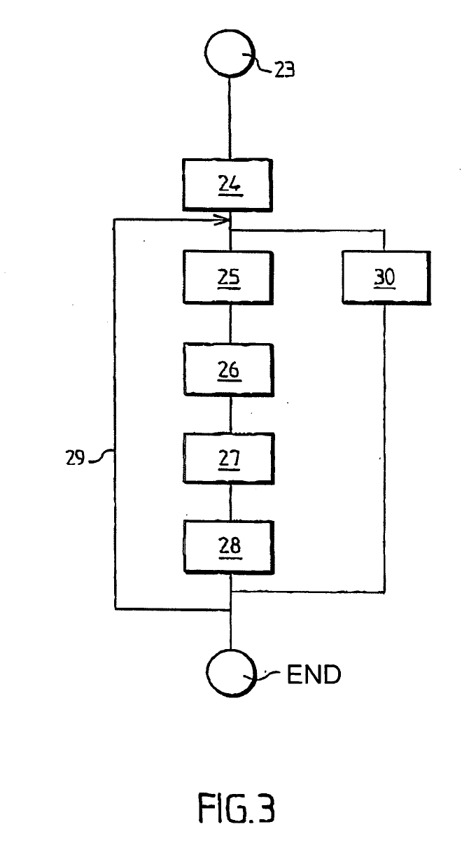

FIG. 3 is a block diagram giving the various steps of the method according to the embodiment of the invention more particularly described here;

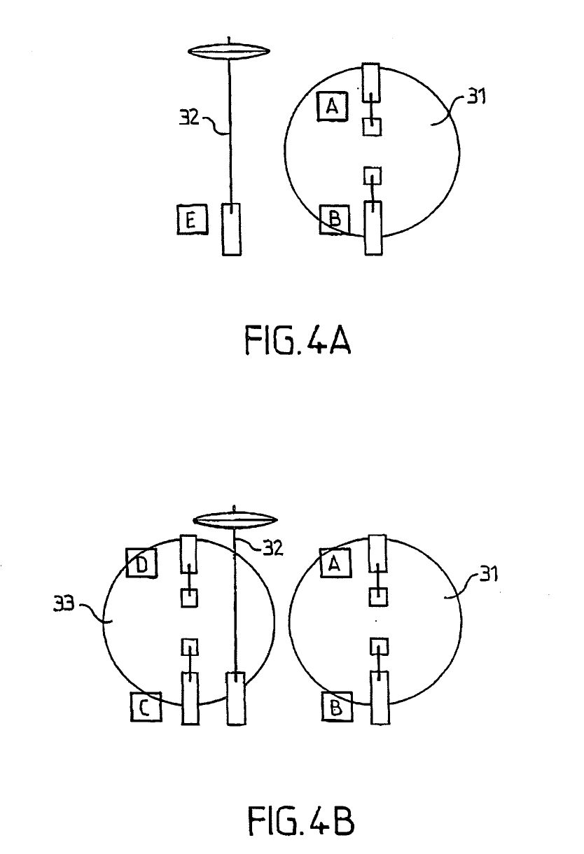

FIGS. 4A and 4B show schematically, and respectively, a bass drum/high-hat set and a two bass drums/high-hat set, according to two embodiments of the invention;

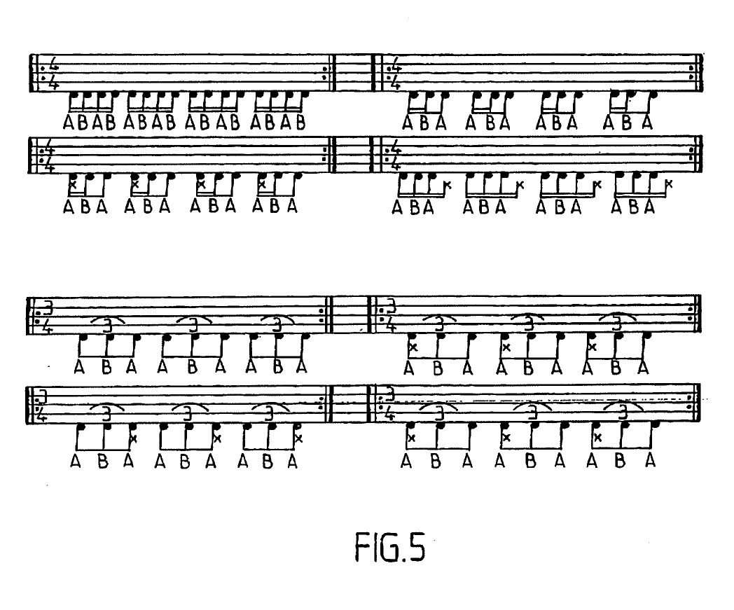

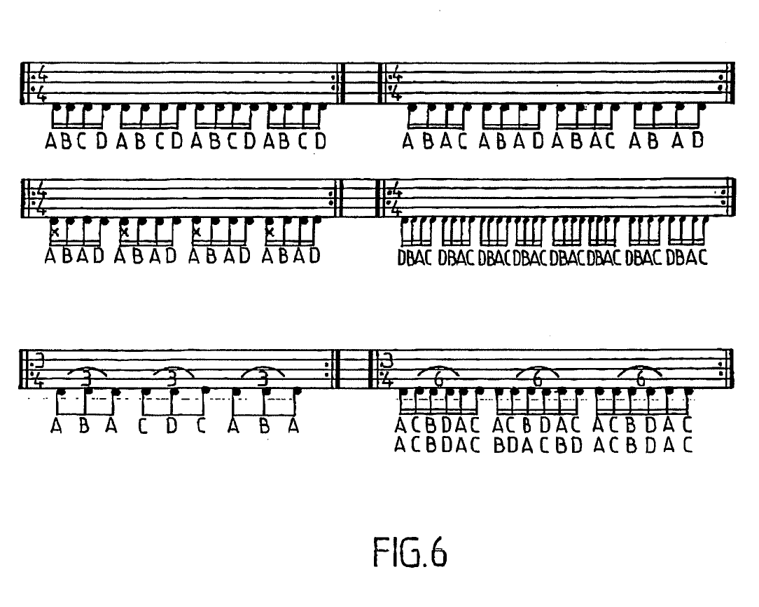

FIGS. 5 and 6 are examples of musical scores written out for drumsets according to the embodiments of the invention corresponding to FIGS. 4A and 4B, respectively;

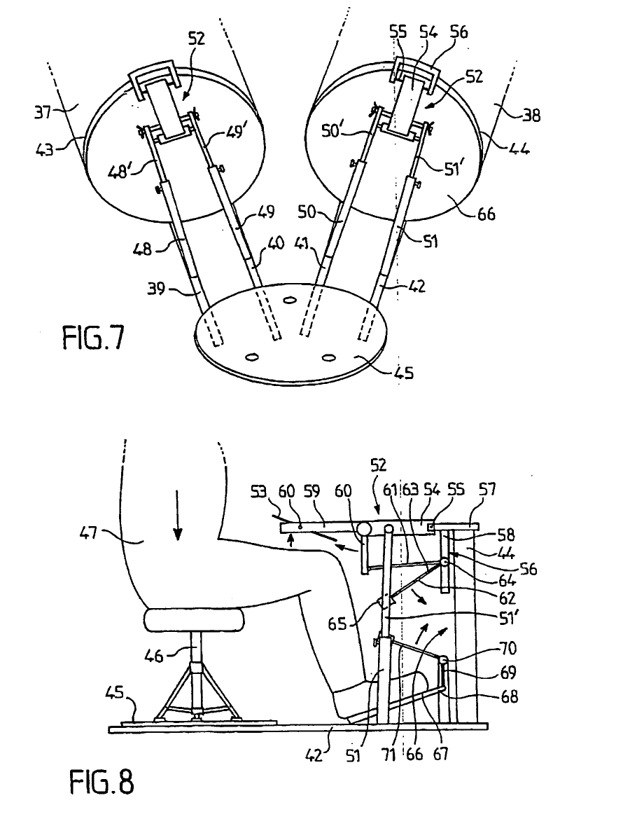

FIG. 7 is a simplified view from above of a set of two bass drums with a plate for fastening the drums and bases for supporting the knee pedals according to one embodiment of the invention; and

FIG. 8 is a side view of one embodiment of the device according to the invention.

FIG. 1 shows schematically a device 1 comprising two bass drums 2, 3.

Each bass drum has a set of two beaters 4, 5 and 6, 7, namely two bottom beaters 4 and 6 and two top beaters 5 and 7.

Each beater is respectively provided with actuating means 4′, 5′, 6′ and 7′ respectively fastened, so that they pivot, to the hoop 8, 9 of the corresponding bass drums.

Hereinafter the same reference numbers will be used to denote the same parts or similar parts. More precisely, each actuating means has a pivoting spindle 10, of the corresponding beater, a pedal 11, 12 suitable for being actuated by the user's foot or knee respectively, and means 13, 14 for transmitting the movement of the pedal to the beater, shown schematically by rods in FIG. 1.

The actuating means 13, 14, comprise, for example, in a manner known per se, a pulley/return chain system as described with reference to FIG. 6.

To implement the percussion method according to the invention, the pedals are actuated by the drummer by means of the upward movement (double arrows 15) of his feet and/or leg.

FIG. 2 shows a first example of a score (allegro tempo) that will be able to be played with the device according to the invention.

The groups of quavers, semiquavers and demisemiquavers 16, 17 and 18 in stave bar 19 corresponding to the bass drum cannot be played at the present time, except with the device and the method according to the invention.

The notes 20 correspond to the snare drum (played with one's hands), the cross 21 in the bottom part of the stave corresponds to the high-hat pedal, and the crosses 22 at the top relate to the cymbals.

FIG. 3 gives the various operating steps for beating the instrument.

At 23, the drummer installs himself at his drumset.

He adjusts the height of his knee pedals 12 (step 24), which will allow him to be slaved to a greater or lesser extent to a knee blow.

If the pedal 12 is adjusted heightwise to be quite high, the drummer can play in traditional mode and selectively in an improved manner, as may be obtained with the invention.

If however the adjustment is lower, a blow with his knee will be systematically obtained.

The drummer then effects in succession (at 25) a first blow with his knee at the [sic] foot, then rapidly (in intervals of less than ¼ of a second), a second blow (with his foot or knee) at 26, a third blow at 27 (with his knee or foot) and at 28 a fourth (with his foot or knee), thus effecting at least four successive—knee/foot/knee/foot blows separated in pairs by times shorter than one quarter of a second.

The percussive blows may then be repeated (arrow 29).

Simultaneously (step 30), the drummer may effect the same operations with a second bass drum, or use a high-hat, etc.

Shown below in tables 1 and 2 and with reference to FIGS. 4A and 4B are examples of bass rhythm combinations:

a single set with bass drum 31 and high-hat 32 (FIG. 4A);

a double set with two bass drums 31 and 33 and high-hat 32.

Each bass drum is provided with two movable members 34 and 35 with beaters, in opposition.

Each beater has been identified by a letter, A, B, C and D, namely A for a blow corresponding to the right foot, B corresponding to the right knee, C corresponds [sic] to the left foot, D corresponding to the left knee and E to the high-hat pedal.

Given below in an entirely nonlimiting manner in tables 1 and 2 are examples of rhythm combinations that constitute a novel way of presenting notes struck by the drummer.

TABLE 1

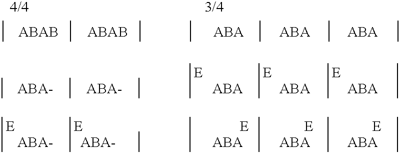

TABLE 2

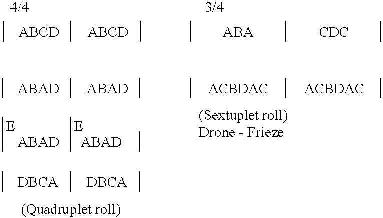

Also shown, in FIGS. 5 and 6, are examples of a music score, again with reference to FIGS. 4A and 4B and the positions of the feet and leg (knee) blows A, B, C and D.

It may be seen that, by means of the invention, a technical result in terms of impact frequency, unequaled in the prior art, is obtained, which allows an entirely novel score configuration unknown hitherto.

There will thus be many applications in the music industry such as, for example, in the printing of new scores, in the manufacture of new pedals and their means of actuation in order to allow the method of the invention to be implemented, and more generally in the concert industry, in advertising (new regular and powerful musical background) and in the manufacture of percussion musical instruments.

FIGS. 7 and 8 show a partial view of a device 36 according to one embodiment of the invention, comprising two bass drums 37 and 38 joined together by means of metal ties 39, 40, 41 and 42 fastened on one side to the respective hoops 43 and 44 of the bass drums 37 and 38 and on the other side to a plate 15 [sic], for example a circular metal plate, on which the seat 46 for the drummer or operator 47 rests.

Thus, the drumsets and the drummer are perfectly linked together and there is no risk of the bass drums moving forward when being repeatedly and rapidly beaten by the drummer.

For each tie, the device comprises an approximately vertical tubular bar 48, 49, 50, 51 fastened some distance away from the plate and designed to be vertically in line with the operator's foot.

A corresponding rod 48′, 49′, 50′ and 51′ which is telescopic and capable of sliding inside the tubular bar, makes it possible to adjust the height of a part 52 that supports the knee/thigh pedal 53 and is mounted horizontally between the two upper ends of the rods 50′ and 51′.

More precisely, the part 52 includes a first end portion 54 fastened in an articulated (nonblocked) manner by a horizontal spindle 55 to a bracket 56 provided with a horizontal branch 57 resting on the upper portion of the hoop and with a vertical branch 58 directed downward. The bracket 56 is secured to the hoop, for example in a removable manner, and a second portion 59, for example in the form of a fork, [lacuna] on the two branches of which is mounted the pedal 53 so that it pivots about a spindle 60, parallel to the spindle 55.

The part 52 is provided, approximately at its middle, with a rod 60′ perpendicular to said part, directed downward and connected at its end to a chain 61 for actuating the beater 62, one end 63 of which is itself fastened so as to pivot at 64 on the bracket 56, in the middle of the vertical branch 58, and the other end of which is provided with a ball 65 for striking the tensioned head 66 of the bass drum.

The device also includes a foot pedal 67 known per se, the end 68 of which is fastened to a chain 69, of the bicycle chain type, for rotating a rack spindle 70 fastened to the beater 71 capable of striking a bass drum.

The combined weight of the body of the user 47, that of the seat 46 and that of the rigid plate 45 and that of the bass drum or drums and their accessories prevents the device in operation from lifting up, the impacts being attenuated by the nonblocked articulation.

The operation of the device will now be described according to the embodiment of the invention more particularly envisioned here, with reference to FIG. 8.

The drummer 47 sits on his seat 46 after having adjusted the height of the rods 51′, placing the foot pedal 53 opposite his knee, to the desired height.

By successive and repeated movements upward by his knee and downward curve of his foot and/or of his leg, the drummer then performs a series of closely-spaced sounds as described above.

By lifting his knee, this strikes the pedal 53, the spindle 60 of which is attached to the fork 59 which itself belongs to the part 52.

The latter pivots about the spindle 55, moving the rigid branch 60 away from the bass drum, entraining the chain 61, which makes the spindle 64 of the beater 62 rotate, the end 65 of which strikes the head of the bass drum.

Simultaneously, or slightly later, his foot actuates the pedal 67 and the beater 7 strikes the bass drum in a manner known per se.

As goes without saying and as also results from the foregoing, the present invention is not limited to the embodiment more particularly described. On the contrary, it embraces all variants thereof and especially those in which another instrument is used for the knee pedal, for example one mounted on a wheel attached to the hoop of the bass drum, and which can be rotated in order to allow an instrument, which varies depending on its position on the wheel, to be placed opposite the beater.

1. A method of producing a series of closely spaced percussive blows on at least one percussion instrument (2, 3; 31, 33; 37, 38) such as a bass drum by a single operator (47), characterized in that the operator actuates, successively and repetitively with his corresponding leg and then his corresponding foot, two movable members (11, 12; 52, 67) each having at one end a beater (4, 5, 6, 7; 63, 71), suitable for beating the percussion instrument in order to produce a drum roll of at least four successive impacts separated in pairs by a time of less than a quarter of a second.

2. The method as claimed in claim 1, characterized in that the successive blows are made by upward movements (15) of the corresponding leg and downward movements (15) of the corresponding foot of the operator.

3. The method as claimed in either of the preceding claims, characterized in that the operator moves the sole of his foot up in order to actuate the beater with his knee.

4. The method as claimed in any one of the preceding claims, characterized in that the operator actuates, at the same time, four beaters (4, 5, 6, 7) with both his legs in order to produce drum rolls on two different bass drums (2, 3).

5. The method as claimed in either of claims 1 and 2, characterized in that the operator actuates, at the same time, on the one hand two beaters on one and the same bass drum (31) and, on the other hand, a “charleyston” (32).

6. The method as claimed in any one of the preceding claims, characterized in that the operator actuates, with only one leg, two beaters (4, 5, 6, 7) in order to strike the same bass drum in an allegro tempo by producing at least two series of four semiquavers in two successive beats.

7. The method as claimed in any one of the preceding claims, characterized in that the operator produces, with the same leg, at least two successive series of four demisemiquavers.

8. The method as claimed in any one of the preceding claims, characterized in that the operator produces a regular succession of at least four blows separated by periods of less than ⅛th of a second.

9. A device (1) for producing a series of closely-spaced percussive blows on at least one percussion instrument (2, 3; 31, 33; 37, 38) by a single operator, characterized in that it comprises at least a set of two beaters (4, 5; 6, 7) placed vertically, one at the top and one at the bottom, in opposition on the percussion instrument, each beater being provided with means of actuation (4′, 5′, 6′, 7′) by one and the same leg/foot combination of the operator, namely the bottom beater (4, 6) by the operator's foot and the top beater (5, 7) by the operator's knee or thigh, simultaneously and/or in succession at very closely-spaced intervals.

10. The device as claimed in claim 9, characterized in that the means of actuating the top beater comprise a mechanism fixed to the percussion instrument and provided with a system having a return chain (61) connected to a movable member (52, 53) suitable for cooperating with the operator's knee and/or thigh.

11. The device as claimed in either of claims 9 and 10, characterized in that it includes a second bass drum (3, 33, 38) and a second set of two beaters (6, 7) with which said second bass drum is equipped, thus offering the operator the possibility of creating successions of sounds of variable intensity and in very fast tempi with his two legs.
